(19) United States
(12) Patent Application Publication
(10) Pub. No.: US 2011/0189638 A1
(43) Pub. Date: Aug. 4, 2011

(54) SYSTEM AND METHOD FOR LEARNING ASSESSMENT

(75) Inventors: ANDRES JIMENEZ, Zionsville, IN (US); Jeanne Armstrong, Lebanon, IN (US)

(73) Assignee: ImplementHIT, Los Angeles, CA (US)

(21) Appl. No.: 12/814,522

(22) Filed: Jun. 14, 2010

Related U.S. Application Data
(60) Provisional application No. 61/300,892, filed on Feb. 3, 2010.

(51) Int. Cl. G09B 19/18

(52) U.S. Cl. 434/107

(57) ABSTRACT

A system for learning assessment comprising, in one example embodiment, comprises a simulator interface to provide to a learner information concerning a continuing education activity and to present a case scenario related to the continuing education activity, a communication module to receive actions performed by the learner at the simulator interface, the actions intended to manage the case scenario, a tracking module to track and record the actions performed by the learner, and an evaluation module to evaluate the actions in view of a predetermined expected action outcome and, based on the evaluation, to produce a score indicative of an ability of the learner to apply the information concerning the continuing education activity. In one example embodiment, the continuing education activity is related to an electronic health record (EHR), the simulator interface is a skin of the EHR, and the learner is a medical provider.

### RELATED APPLICATIONS

This application claims the benefit of the filing date of Provisional Application 61/300,892 filed on Feb. 3, 2010, which is incorporated herein by reference.

### FIELD

The present invention relates generally to learning assessment. More specifically, the present invention relates to assessment of learning of a software application in a simulated environment.

### BACKGROUND

Professional continuing education is a learning activity which typically results in the issuance of a certificate or continuing education units for the purpose of documenting attendance at a designated seminar or course of instruction. Licensing bodies in a number of fields impose continuing education requirements on members who hold licenses to practice within a particular profession. These requirements are intended to encourage professionals to expand their knowledge base and stay up-to-date on new developments. Online continuing education programs have become popular because they allow professionals to satisfy continuing education requirements without having to leave their workplace or from home. Traditionally, such online learners have been tested with multiple-choice questions. However, multiple-choice questions are a poor indicator of the retained knowledge where practical, hands-on skills are being taught.

For example, in the medical profession, electronic medical record (EMR) and electronic health record (EHR) (sometimes used interchangeably) have been evolving concepts representing systematic collections of electronic health information about individual patients or populations. EHR includes records in a digital format that is capable of being shared across different health care settings, by being embedded in network-connected enterprise-wide information systems. Such records may include a whole range of data in comprehensive or summary form, including demographics, medical history, medication and allergies, immunization status, laboratory test results, radiology images, and billing information.

However, health care providers adopting EHR often observe that any gains in efficiency are offset by reduced productivity as the technology is implemented. One of the main factors contributing to the reduction in productivity is the difficulty related to training of employees to use an EHR system.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing a sample network environment within which a system and method for learning assessment are implemented, in accordance with an example embodiment;

FIG. 2 is a block diagram showing a simulator, in accordance with an example embodiment;

FIG. 3 is a flow chart showing a method for learning assessment, in accordance with an example embodiment;

FIG. 4 is a flow chart showing a method for learning assessment of a medical provider, in accordance with an example embodiment;

FIG. 5 is a block diagram showing a sample server environment within which a system and method for learning assessment are implemented, in accordance with an example embodiment;

FIG. 6 is a screenshot of a simulator interface, in accordance with an example embodiment;

FIG. 7 is a screenshot of a simulator interface, in accordance with an example embodiment; and

FIG. 8 is a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed by introducing structural, logical or electrical changes without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Using an EHR system, doctors, or other medical personnel can enter patient data electronically. The data can include patient's medical history and allergies. Using the EHR, a doctor can evaluate patient's condition and enter a diagnosis, write prescriptions, and order further laboratory tests. Instead of having to review paper records, a doctor can review patient's history online. One of the downsides is that a hospital may have to pay millions of dollars for an EHR system that medical personnel do not learn to utilize to its full potential because they are not familiar with the system and the conventional training is not effective.

The system and method for learning assessment can create an exact representation of an EHR which can be used by a learner to go through various real life scenarios. For example, a doctor using the system for learning assessment can review the patient's information, diagnose the patient, and prescribe appropriate medications, laboratory tests, and treatment. While the doctor goes through the process, the system can track doctor's actions, so that in the end of the simulation the doctor can be evaluated as to whether he has demonstrated sufficient understanding of how the EHR functions.

Training is one of the most important components of an EHR implementation. The system and method for learning assessment, in some example embodiments, allow focusing on using online training resources to help physicians and other medical personnel achieve meaningful use of an EHR. First, by moving core functionality training to an efficient online training platform, physician productivity can be protected since participation in online training allows physicians to remain in clinic. More convenient training can produce greater “buy-in” by learners, and more meaningful learning results in increased use of the EHR. To ensure optimal integration of an online training program with live training, system and method for learning assessment can also provide a problem based live training curriculum developed by EHR training experts, combined with dedicated time to “train the trainer”.

The system and method for learning assessment is a simulator technology that allows creation of virtual demonstrations of EHR workflows tailored to specific medical specialties by using specific sample patient data. The sample patient data can be reused when a virtual EHR is used by a learner in a practice or an assessment session while the learner's movements are tracked and recorded.

This approach can allow learners practicing usage of the EHR to perform EHR functions within real live scenarios. Patient information can be pulled from a database and used by the simulator that simulates an EHR interface. Depending on which EHR is being simulated, the system and method for learning assessment can utilize various skins, each skin representing an EHR. Regardless of what particular EHR is being simulated, the learner's actions can be tracked as he performs EHR functionalities. The system and method for learning assessment, in some example embodiments, can include simulator and evaluator interfaces.

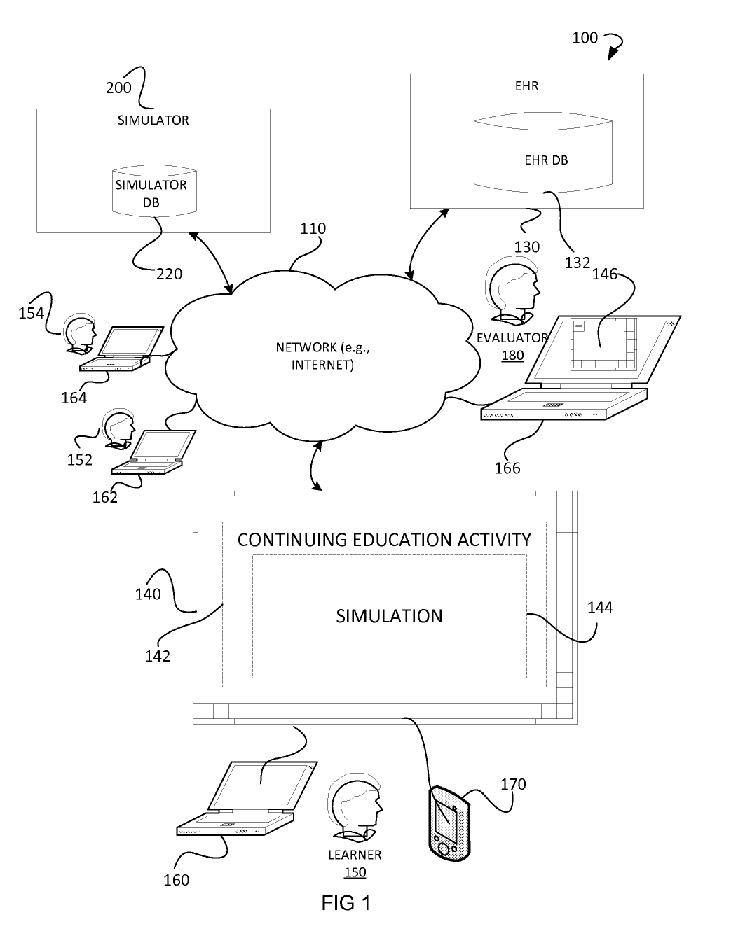

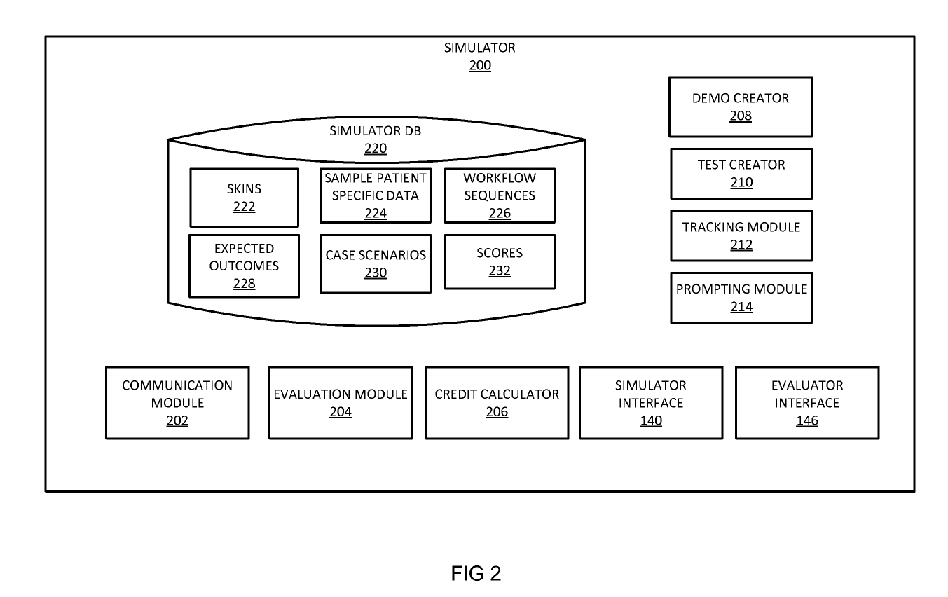

FIG. 1 is a block diagram showing a sample network environment 100 within which a system and method for learning assessment are implemented, in accordance with an example embodiment. As shown in FIG. 1, the sample network environment 100 can comprise a network 110, an Electronic Health Record (EHR), a simulator interface 140, learners 150, 152, and 154, computers 160, 162, 164, and 166, a mobile device 170, and an evaluator 180. The EHR can, in turn, include an EHR database. The computer 166 can be utilized by the evaluator 180 to review actions of the learner 150 using an evaluation interface 146 upon learner's completion of a simulation session 144 within a continuing education activity 142. The sample network environment 100 can further include a simulation database 220. The simulator 200 is described in more detail below with reference to FIG. 2.

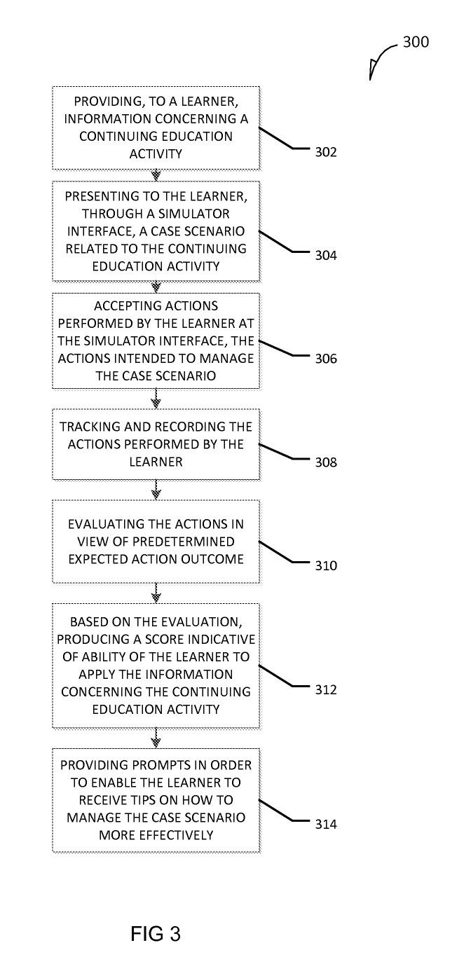

FIG. 2 is a block diagram showing the simulator 200, in accordance with an example embodiment. As shown in FIG. 2, the simulator 200 can comprise the simulator DB 220, a communication module 202, an evaluation module 204, a credit calculator 206, the simulator interface 140, the evaluator interface 146, a demo creator 208, a test creator 210, a tracking module 212, and a prompting module 214. The simulator DB 220 can, in turn, include data related to skins 222, sample patient data 224, workflow sequences 226, expected outcomes 228, case scenarios 230, and scores 232. Sample operations of the foregoing modules described in more detail with reference to the method 300 of FIG. 3 below.

FIG. 3 is a flow chart showing a method for learning assessment 300, in accordance with an example embodiment. The method 300 can be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides at the simulator 200 illustrated in FIG. 2.

The method 300 can commence at operation 302 with the simulator interface 140 providing to the learner 150 the sample patient specific data 224 concerning the continuing education activity 142. At operation 304, the simulator interface 140 can present to the learner 150 one of the case scenarios 230 created by the test creator 214. The simulator interface 140 is created using one of the skins 222 tailored to simulate the EHR to which the continuing education activity 142 is directed. At operation 304, the simulator interface 140 can accept actions performed by the learner 150 at the simulator interface 140, the actions intended to manage the case scenario. The actions of the learner 150 can include entering a diagnosis, prescribing a medication, and ordering a laboratory test. The learner 150 can receive prompts created by the prompting module 218 in order to enable the learner to receive tips on how to manage the case scenario more effectively.

At operation 306, the actions performed by the learner 150 can be tracked and recorded by the tracking module 216. At operation 308, the evaluation module 204 can evaluate the actions performed b the leaner 150 by comparing the recorded actions to the expected outcome 228. Based on the evaluation, at operation 308 a score can be produced by the evaluation module 204. The score is indicative of ability of the learner 150 to apply the information concerning the continuing education activity. The score can be used to verify participation of the learner 150 in the continuing education activity 142. Additionally, the score can be used to grant the learner appropriate continuing education credits.

The system and method for learning assessment, in some example embodiments, allows tracking the click map and what screens the learner goes through using the tracking module 216. The sample data specific data 224 can be reviewed and when the process is complete, the evaluator 180 can view the notes for the patient written or selected (e.g. clicking a checkbox within the simulated HER) by the learner 150. Other data evaluated can include prior medical history, surgeries history, family history, and social history. For example, the family history can be reviewed for the details of the colon cancer if symptoms include bleeding.

A doctor can come to a conclusion that this patient needs a certain test and based on this conclusion, proceed to order the test. Because doctor's actions are recorded by the tracking module 216, it can later be determined whether the doctor understands how to use the EHR to order the test. The system can have patient data assigned to a specific scenario. For each of these scenarios, a doctor may have a specific route to be taken through the system. The simulator database 220 utilized by the system can be entirely separate from the EHR database 132 used by the EHR 130 but the structures of these two databases can be similar. The system can include thousands of medications to prescribe, just like any EHR system, allowing doctors to search and select medication.

The evaluator is 180 can be aware what medicine or medicines the doctor is expected to prescribe based on the diagnosis entered by the doctor. By viewing the log with recorded learner's actions, the evaluator can determine whether the medicine is correctly prescribed. Thus, two goals can be accomplished by the system and method for learning assessment, practicing usage without overwriting patients' medical records and determining the learner's understanding of the system.

In one example embodiment, the system for learning assessment may provide a video, digital text, or live demonstration of a continuing medical education (CME) activity that a medical provider that seeks to continually educate herself may watch in order to learn how to better treat a specific medical problem.

After the medical provider has finished watching the CME activity, the system for learning assessment may, through an electronic medical record (EMR) simulator computer application, present the medical provider with a clinical case scenario related to the CME activity. The medical provider may be presented with a patient from their daily schedule with a complaint related to the CME activity. The medical provider may also be presented with the patient's information from within the patient's electronic chart, as presented by an EMR skin being emulated to represent the EMR the provider uses in their real life practice. The system for learning assessment may then allow the medical provider to manage a simulated patient's care using the EMR. Any actions performed by the medical provider (such as computerized order entry, electronic prescribing, etc.), along with the sequence of steps the medical provider follows, may be monitored by the EMR simulator.

The system for learning assessment may use the EMR simulator to provide prompts in order to enable the medical provider to get tips on how to more effectively manage the simulated patient's care. The system for learning assessment may use the EMR simulator to assess the ability of the medical provider in applying the information acquired from the CME activity by scoring their management of the simulated patient on the EMR simulator, such as via the medical provider's specific orders for medications, labs, or any other appropriate action performed through the EMR simulator. The system for learning assessment may then use the EMR simulator to produce a score that may be used to verify participation in the CME activity and grant the medical provider the appropriate CME credits. The score may be used as a means of verifying the medical provider's participation in the learning activity, and the EMR simulator may award the appropriate amount of CME credits to the medical provider.

The EMR simulator may further contain a database of case scenario information, such as patient medical history data, scoring logic on patient management, and data for efficient EMR use. The case scenario information may be used by the EMR simulator in order to operate as a system for learning assessment, such as by using logic housed in the database for the EMR skin being emulated in order to provide clues to the medical provider on how to more effectively use their EMR simulator, as well as score the medical providers management of the patient's care. The EMR simulator may be a FLASH™ based application that pulls patient, and CME assessment data from a database. The EMR simulator may have different “skins” that may emulate different EMRs, and populate different components of the “skin” with the patient data from the database. The EMR simulator may allow the medical provider to manage the patient's care using computerized order entry, and electronic prescribing following workflows specific to the EMR skin it may be emulating. Based on the series of actions put forth by the medical provider, the correct actions found in the database for that simulated patient scenario, and the scoring logic, the EMR simulator may generate a score for the medical provider's management of the simulated patient. The database may also provide workflow sequence information and cues to the medical provider if they are not following the most efficient workflow for appropriately managing the patient (EMR guidance). The score produced may be used to award the medical provider the appropriate amount of CME credits.

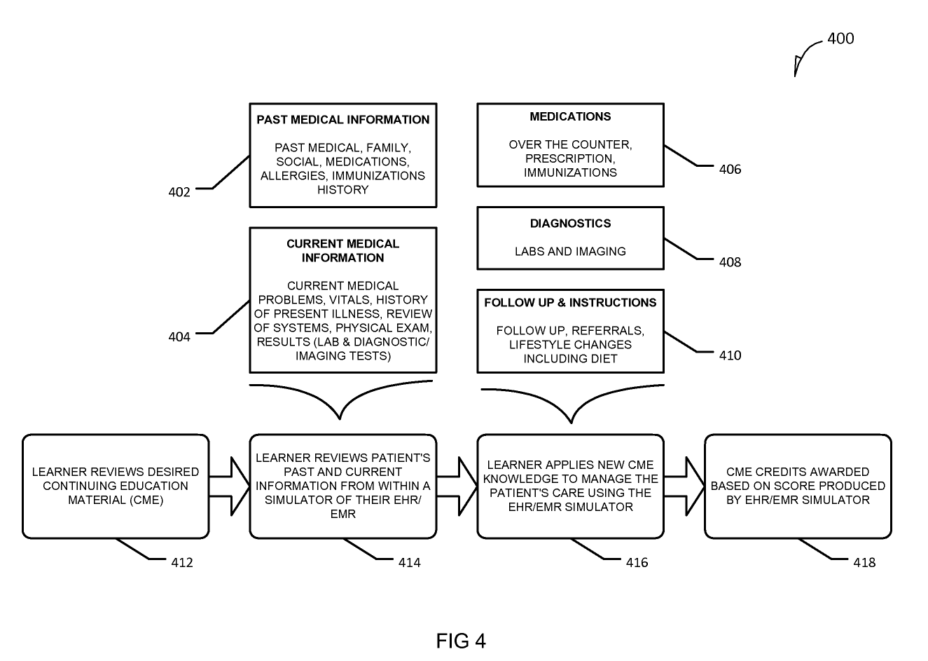

FIG. 4 is a flow chart showing a method 400 for learning assessment of a medical provider, in accordance with an example embodiment. As shown in FIG. 4, the method 400 can commence at operation 412 with the learner 150 reviewing the desired continuing education materials. At operation 414, the learner 150 can review past medical information 402 and current medical information 404 from within the simulator 200. The past medical information 402 can include past medical, family, social, medications, and immunizations history. The current medical information 404 can include current medical problems, vitals, history of present illness, and review of the systems, physical exam, results (lab and diagnostic/imaging test).

At operation 416, the learner 416 can apply his CME knowledge to manage the patient's care using the simulator 200. This can include prescribing medications 206, ordering diagnostics 408, and follow-ups and instructions 410. The medications 406 can include over-the-counter medications, prescription medications, and medications used for immunizations. The diagnostics 408 can include laboratory and imaging tests. The follow-ups and instructions 410 can include follow-ups, referrals, and lifestyle changes, including diet. At operation 418, the CME credits can be awarded based on the score produced by the simulator 200.

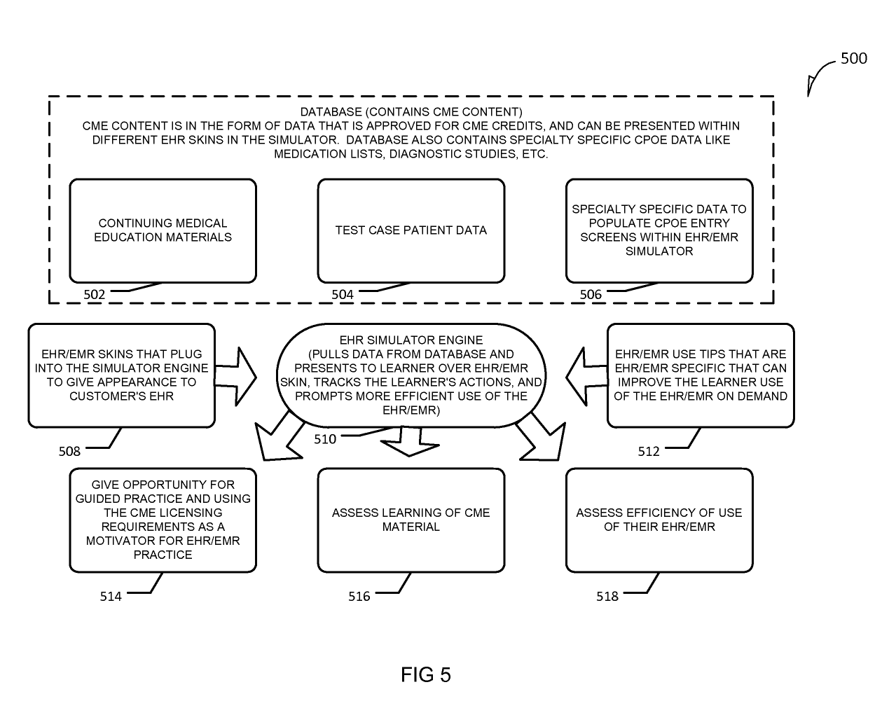

FIG. 5 is a block diagram showing a sample server environment 500 within which a system and method for learning assessment are implemented, in accordance with an example embodiment. As shown in FIG. 5, the simulator DB 220 can include Continuing Medical Education (CME) content. The CME content can be in the form of data that is approved for CME credits, and can be presented within different EHR skins in the simulator 200. The simulator DB 220 can also contain specialty specific Computerized Physician Order Entry (CPOE) data like medication lists and diagnostic studies. The simulator DB 220 can comprise continuing medical education materials 502, test case patient data 504, and specialty specific data 506 to populated CPOE entry screens within the simulator 200.

Skins 508 can plug into the simulator 200 to give appearance of the customer's EHR. Specific EHR/EMR tips 512 can be provided that can improve the learner's use of the EHR/EMR on demand. The simulator 200 can pull the data from the simulator DB 220 and present it to the learner 150 over the EHR/EMR skin, track the learner's actions, and prompt more efficient use of the EHR/EMR. As a result, three objectives can be achieved. First, an opportunity for the guided practice and using the CME licensing requirements as a motivator for EHR/EMR practice is provided. Second, assessment learning of CME material is performed. Third, assessment of the usage of the EHR/EMR is performed.

It will be understood that the system for learning assessment tool is not limited to any particular field and may be used to verify participation in a learning activity in any industry besides the medical industry for which a learner may be expected to continually learn to maintain licensure. For example, the system may include a simulator application that can score the learner's actions and workflow sequence steps within an accounting software application while also providing cues for more efficient use of the simulator. Such a system may produce a score that is used to verify participation in the learning activity as well as attainment of industry specific continuing education credit (CPE, or Continuing Professional Education credit for accounting).

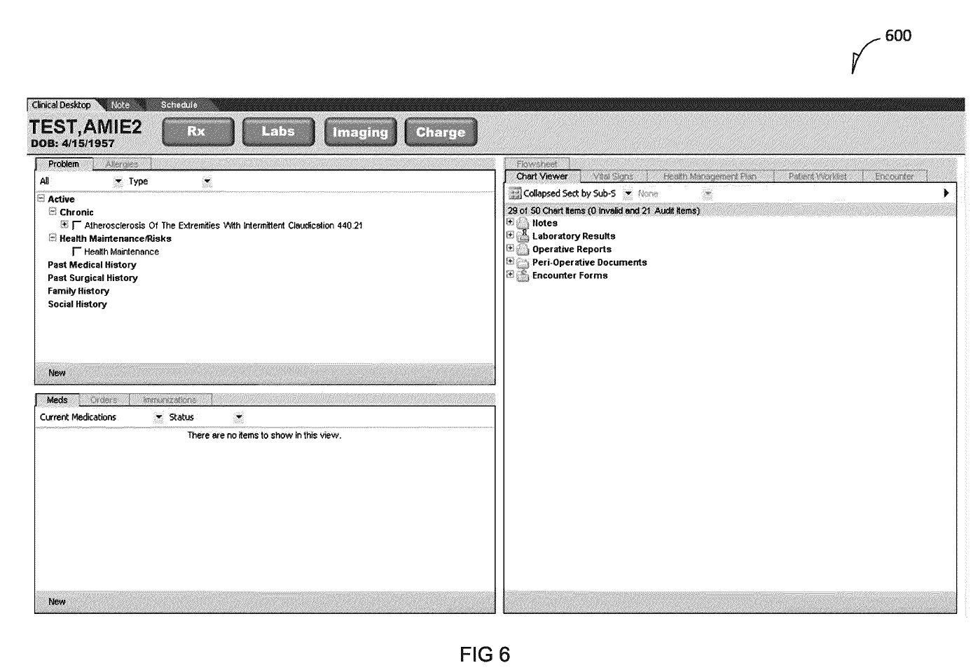

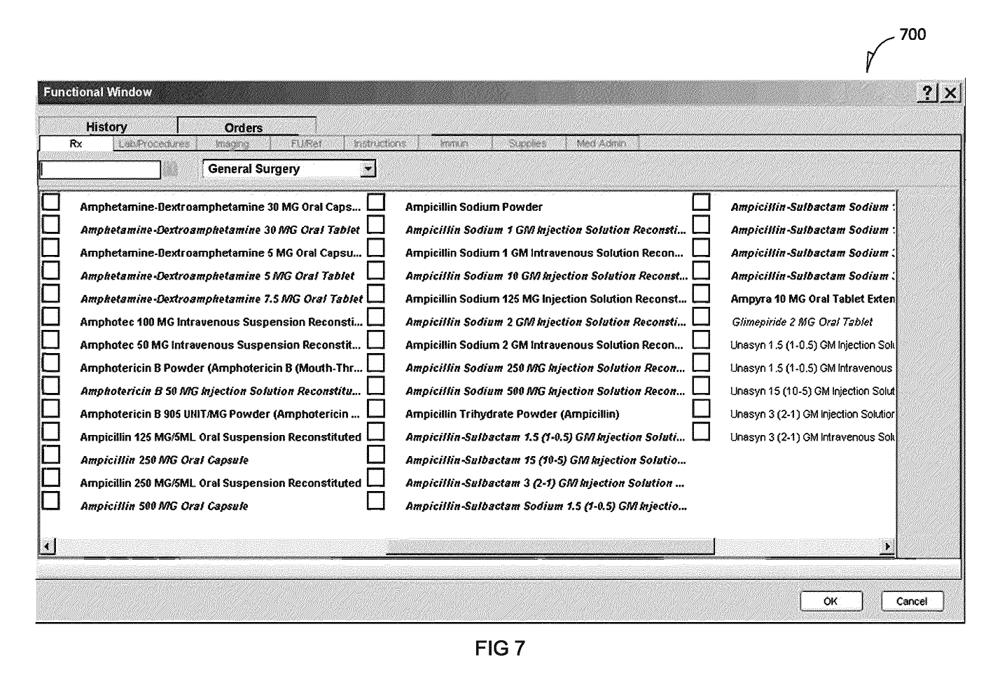

It should be understood, of course, that the foregoing relates to exemplary embodiments of the invention and that modifications may be made without departing from the spirit and scope of the invention as set forth in the following claims. FIGS. 6 and 7 are screenshots 600 and 700 respectively of the simulator interface 140, in accordance with an example embodiment.

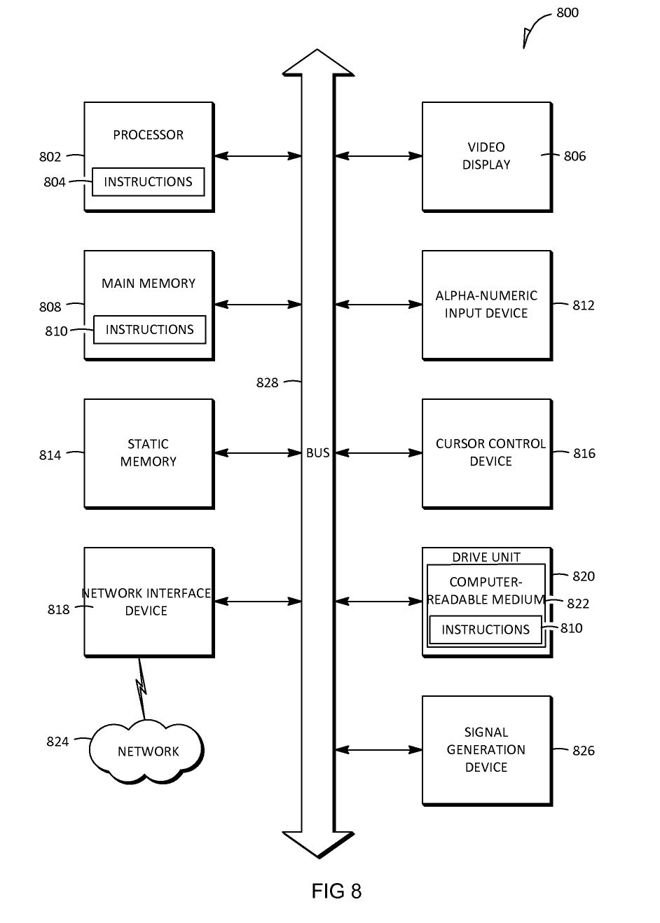

FIG. 8 is a diagrammatic representation of an example machine in the form of a computer system 800, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor or multiple processors 802 (e.g., a central processing unit (CPU), a graphics processing unit (GPU), or both), and a main memory 808 and static memory 814, which communicate with each other via a bus 828. The computer system 1000 may further include a video display unit 806 (e.g., a liquid crystal display (LCD)). The computer system 800 may also include an alphanumeric input device 812 (e.g., a keyboard), a cursor control device 816 (e.g., a mouse), a voice recognition or biometric verification unit, a disk drive unit 820, a signal generation device 826 (e.g., a speaker) and a network interface device 818. The computer system 800 may further include a data encryption module (not shown) to encrypt data.

The disk drive unit 820 includes a computer-readable medium 822 on which is stored one or more sets of instructions and data structures (e.g., instructions 810) embodying or utilizing any one or more of the methodologies or functions described herein. The instructions 810 may also reside, completely or at least partially, within the main memory 808 and/or within the processors 802 during execution thereof by the computer system 800. The main memory 808 and the processors 802 may also constitute machine-readable media.

The instructions 810 may further be transmitted or received over a network 824 via the network interface device 818 utilizing any one of a number of well-known transfer protocols (e.g., Hyper Text Transfer Protocol (HTTP)).

While the computer-readable medium 822 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, example embodiments of system and method for learning assessment have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A computer-implemented method for learning assessment comprising:
providing, to a learner, information concerning a continuing education activity;
presenting to the learner, through a simulator interface, a case scenario related to the continuing education activity;
accepting actions performed by the learner at the simulator interface, the actions intended to manage the case scenario;
tracking and recording the actions performed by the learner;
evaluating the actions in view of a predetermined expected action outcome; and
based on the evaluation, producing a score indicative of an ability of the learner to apply the information concerning the continuing education activity.

2. The computer-implemented method of claim 1, wherein the continuing education activity is related to an electronic health record (EHR), the simulator interface is a skin of the EHR, and the learner is a medical provider.

3. The computer-implemented method of claim 2, wherein the information includes a patient's electronic chart.

4. The computer-implemented method of claim 2, wherein the actions include one or more of the following: entering a diagnosis, prescribing a medication, and ordering a laboratory test.

5. The computer-implemented method of claim 1, wherein the information includes one or more of the following: a video, a digital text, and a live demonstration of the continuing education activity.

6. The computer-implemented method of claim 1, further comprising providing prompts in order to enable the learner to receive tips on how to manage the case scenario more effectively.

7. The computer-implemented method of claim 1, wherein the score is used to verify participation of the learner in the continuing education activity.

8. The computer-implemented method of claim 1, wherein the score is used to grant the learner appropriate continuing education credits.

9. A system for learning assessment comprising:
a simulator interface to provide to a learner information concerning a continuing education activity and to present to the learner a case scenario related to the continuing education activity;
a communication module to receive actions performed by the learner at the simulator interface, the actions intended to manage the case scenario;
a tracking module to track and record the actions performed by the learner; and
an evaluation module to evaluate the actions in view of a predetermined expected action outcome and, based on the evaluation, to produce a score indicative of an ability of the learner to apply the information concerning the continuing education activity.

10. The system of claim 9, wherein the continuing education activity is related to an electronic health record (EHR), the simulator interface is a skin of the EHR, and the learner is a medical provider.

11. The system of claim 10, wherein the information includes a patient's electronic chart.

12. The system of claim 10, wherein the actions include one or more of the following: entering a diagnosis, prescribing a medication, and ordering a laboratory test.

13. The system of claim 9, wherein the information includes one or more of the following: a video, a digital text, and a live demonstration of the continuing education activity.

14. The system of claim 9, further comprising a prompting module to provide prompts in order to enable the learner to receive tips on how to manage the case scenario more effectively.

15. The system of claim 9, wherein the score is used to verify participation of the learner in the continuing education activity.

16. The system of claim 9, wherein the score is used to grant the learner appropriate continuing education credits.
